(19) United States
(12) Patent Application Publication
(10) Pub. No.: US 2012/0027961 A1
(43) Pub. Date: Feb. 2, 2012

(54) Decorating Assembly and Methods of Use Thereof

(76) Inventor: Phyllis Fogle, Aurora, CO (US)

(21) Appl. No.: 12/846,805

(22) Filed: Jul. 29, 2010

(51) Int. Cl. A47G 33/08; F21S 4/00; B23P 11/00

(52) U.S. Cl. 428/8; 29/428; 428/7

(57) ABSTRACT

Decorating assemblies and methods of use are disclosed herein. An exemplary decorating assembly for decorating a tree includes a base member and one or more ornamental strings. The base member typically has an aperture disposed in the approximate center of the base member, a rim section, a trough section, and a plurality of slots extending generally vertically from a top edge of the rim section proximal the trough section. An exemplary method of decorating a tree with a decorating assembly includes providing the decorating assembly, typically preassembled within a container, holding the one or more ornamental strings in one hand while placing the base member on the top of the tree. Then, the one or more ornamental strings can be spread onto the tree in various configurations.

### FIELD OF THE INVENTION

The present invention relates generally to decorations. More particularly, the present invention relates to decorating assemblies and methods of decorating trees.

### BACKGROUND

Decorating a tree for the Christmas or the holiday season is arduous and time consuming. Moreover, removing most decorations from the tree and storing the decorations until it is time to use them again is a similarly unenviable activity. Decorating a tree typically includes many activities such as but not limited to placing lights on the tree, wrapping garland or other stringed decorations, and hanging ornaments. While there are countless other means to further decorate a tree, these similarly add significant time to the decorating and removal/cleanup process as opposed to helping busy persons save time during the hectic holiday season. Nevertheless, the majority of people, as busy as they may be, desire to decorate a tree to celebrate the holiday season.

As time crunched as many people are, they continuously seek a way to save time and be more efficient in their daily lives. This objective is exacerbated during the hectic holiday season, particularly with the daunting task of decorating a tree. Heretofore, an apparatus and method that can reduce the time necessary to provide a simple yet beautifully decorated tree as well as minimizing the time necessary to remove and store the decorations remains a long felt need of many individuals.

### BRIEF DESCRIPTION OF THE FIGURES

FIG. 1 is a perspective view of an annular base member of a decorating assembly according to an embodiment.

FIG. 2 is an overhead plan view of a decorating assembly according to an embodiment.

FIG. 3 is a perspective view of a user decorating a tree with a decorating assembly according to an embodiment.

FIG. 4 is an overhead plan view of a decorating assembly whereby one or more ornamental strings comprises a light strand according to an embodiment.

### DETAILED DESCRIPTION

Embodiments of the present invention comprise decorating assemblies and methods of decorating. The decorating assembly comprises a base member, typically annular, and one or more ornamental strings. The base member typically comprises an aperture, a rim section, a trough section, and a plurality of slots disposed along the rim section. In some but not all embodiments the aperture, rim section, and trough section are generally circular in nature. Additionally, the base member can include a plurality of supporting arms and an elevation section, such as a generally frustoconical section used with annular base members.

The one or more ornamental strings are typically removably coupled to the base member to enable changing and replacement of the one or more ornamental strings providing the decorative effect. Many ornamental strings comprise alternating ornate portions and connective portions whereby the ornate portions are typically larger than the connective portions. The ornate portions should be large enough so as they do not to fit through the slots in the rim section while residing in the trough section of the base member. The connective portions are typically thinner than the ornate portions and are adapted to fit into the slots thereby keeping the ornate portion generally within the trough section and fixing the ornamental string in place.

In some embodiments the one or more ornamental strings can be a single ornamental string whereby ornate portions are generally interlaced with the base member to lock the single ornamental string in place to the appropriate configuration of a given tree or application. This configuration is particularly useful when the single ornamental string is a light strand thereby enabling a user to interlace the light strand one time to fit his or her specific tree. Then, the base member and the light strand can be removed together as a one-piece decorating assembly that is now custom fit to that specific tree and can be quickly reapplied the following year.

In use, embodiments of the decorating assembly are typically applied to a tree, such as a real or artificial Christmas tree during the holiday season. However, embodiments can be used in other contexts and for other festive occasions such as, but not limited to, weddings and birthday parties. Moreover, in some embodiments, no assembly is required and the decorating assembly comes prepackaged and ready to use making it a great time saver during the busy holiday season.

### Terminology

The terms and phrases as indicated in quotes (“ ”) in this section are intended to have the meaning ascribed to them in this Terminology section applied to them throughout this document including the claims unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive rather the term is inclusive meaning: either or both.

References in the specification to “one embodiment”, “an embodiment”, “an alternative embodiment” and similar phrases mean that a particular feature, structure, or characteristic described in connection with the embodiment is included in at least an embodiment of the invention. The appearances of the phrase “in one embodiment” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

The term “removable,” “removably coupled,” “readily removable,” “threadably coupled,” and similar terms, as used in this specification and appended claims, refer to structures that can be uncoupled from an adjoining structure with relative ease (i.e., non-destructively and without complicated or time consuming process), and can also be readily reattached or coupled to the previously adjoining structure.

Directional and/or relationary terms such as, but not limited to, left, right, top, bottom, vertical, horizontal, back, front and lateral are relative to each other and are dependent on the specific orientation of an applicable element or article, and are used accordingly to aid in the description of the various embodiments and are not necessarily intended to be construed as limiting.

As applicable, the terms “about” and “generally” as used herein unless otherwise indicated mean a margin of +−20%. Also, as applicable, the term “substantially” as used herein unless otherwise indicated means a margin of +−10%. Concerning angular measurements, “about” or “generally” refer to +−10 degrees and “substantially” refers to +−5.0 degrees unless otherwise indicated. It is to be appreciated that not all uses of the above terms are quantifiable such that the referenced ranges can be applied.

The term “ornamental strings” as used in this specification and the appended claims, unless clearly intended otherwise, refers generally to any contiguous decorative article. Many ornamental strings such as, but not limited to, bead garland and light strands comprise larger ornamental portions generally alternating with connective portions. Ornamental portions can consist of, but are not limited to, beads, light-emitting bulbs, balloons, bells, candies, popcorn, and knots. However, some ornamental strings can be mainly uniformly distributed contiguous decorative articles such as, but not limited to, tinsel garland, streamers, and ribbons.

### An Exemplary Embodiment of a Decorating Assembly

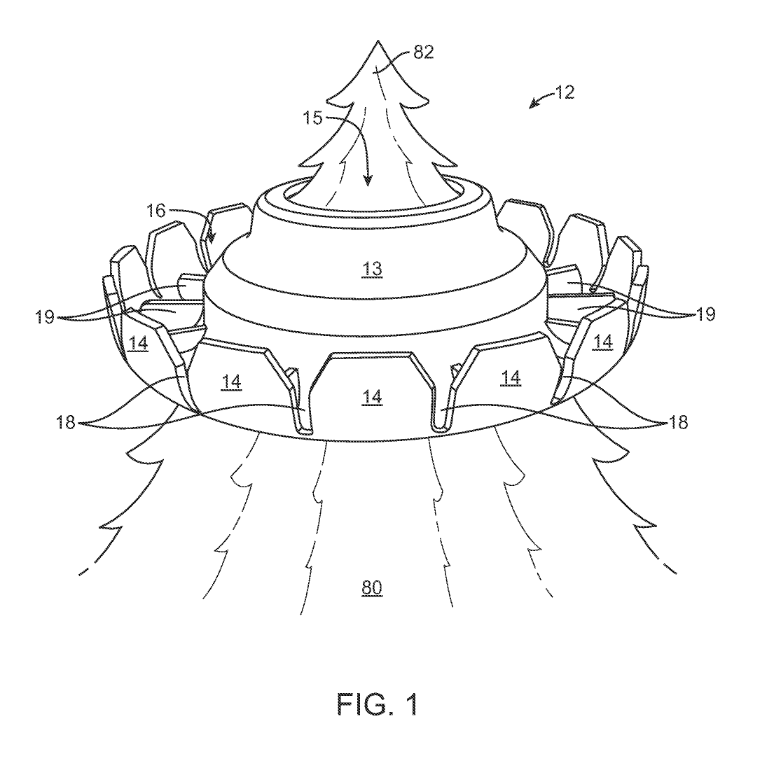

An exemplary decorating assembly 10 is illustrated in FIGS. 1-4. The decorating assembly 10 typically comprises: a base member 12 and one or more ornamental strings 50. The base member 12 is typically a unitary annularly-shaped piece. However, it is to be appreciated that embodiments of the base member can include various shapes, such as but not limited to, a triangle, square, rectangle, pentagon, and hexagon. Moreover, while the base member 12 is typically a single molded piece, some implementations can be comprised of a plurality of pieces to create this functional apparatus.

As best illustrated in FIG. 1, the base member 12 typically comprises an aperture 15, a circumferential trough section 16, a circumferential rim section 14, and a plurality of slots 18. Each of the plurality of slots 18 extends generally vertically from a top edge of the circumferential rim section 14 to proximal the circumferential trough section 16. Hence, a plurality of tabs is created along the circumferential rim section 14 alternating with each of the plurality of slots 18. The slots 18 can also comprise widened opening portions disposed proximal the top edge of the circumferential rim section 14 to enable ease of insertion of the one or more ornamental strings 50. Hence, the plurality of tabs will have a tapered configuration on the top edge of the circumferential rim section 14.

Moreover, a plurality of supporting arms 19 can be included in the base member 12 to provide structural support for each of the plurality of tabs along the circumferential rim section 14 and to define segments within the circumferential trough section 16. The plurality of supporting arms 19 generally extend radially from an inner wall of the circumferential trough section 16 proximal the aperture 15 to the plurality of tabs of the circumferential rim section 14. The plurality of supporting arms 19 are typically disposed in the approximate center of the plurality of tabs of the circumferential rim section 14.

The base member 12 can also include a generally frustoconical section 13 extending from a top edge forming the aperture 15 to the circumferential trough section 16. The generally frustoconical section 13 typically has a smaller diameter at the top edge forming the aperture 15 and a greater diameter at the portion leading to the circumferential trough section 16. The generally frustoconical section 13 and the aperture 15 serve to secure the base member 12 to a generally elongated member such as, but not limited to, a top branch 82 of a tree 80. Also, it is pertinent to note that in some implementations the generally frustoconical section can be cylindrical in nature.

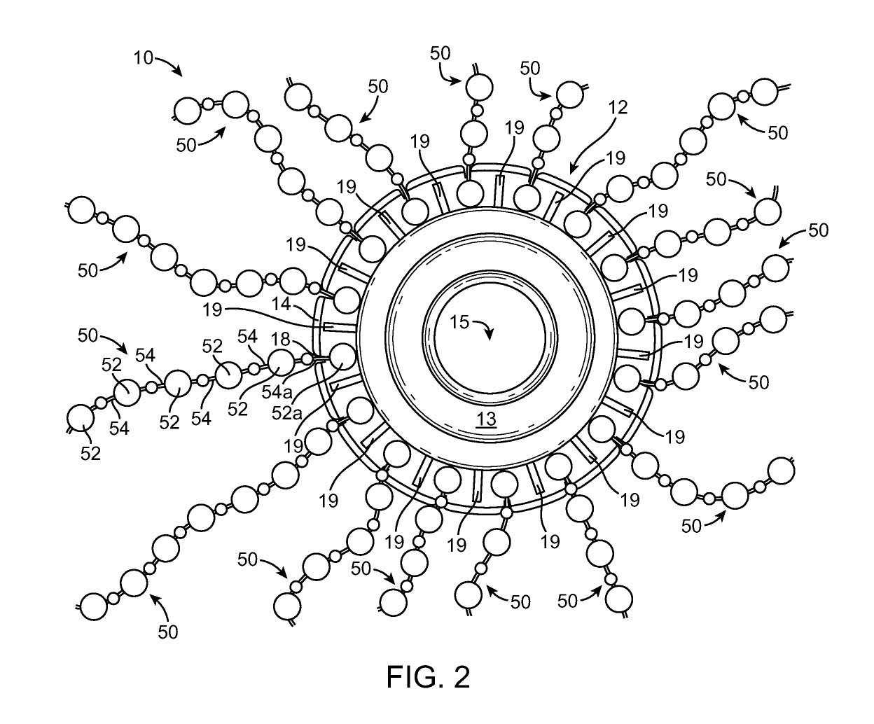

As can be seen from the overhead views of FIGS. 2 & 4, the aperture 15 is disposed in the approximate center of the base member 12. The diameter of the aperture 15 (and the general diameter of an inner cavity formed by the generally frustoconical section 13) can vary substantially depending on the implementation of the decorating assembly 10. For example, if the intended use of the decorating assembly 10 is for a large outdoor tree, the diameter of the aperture 15 will typically be larger than that of an embodiment of the decorating assembly 10 intended for use with a standard-sized indoor artificial Christmas tree. It is to be appreciated that the base member is typically constructed to be light weight (e.g., under approximately 1.5 ounces), yet durable and strong (e.g., capable of supporting 125 pounds of direct pressure without breaking or substantially deforming).

The one or more ornamental strings 50 are typically removably coupled to the base member 12. Various methods exist for removably coupling the one or more ornamental strings 50 to the base member 12 such as, but not limited to, those illustrated and described herein. Moreover, the one or more ornamental strings 50 can comprise a wide array of contiguous decorative articles. However, many ornamental strings 50 comprise alternating ornate portions 52 and connective portions 54. The ornate portions 52 are typically larger than the connective portions 54. The ornate portions 52 are large enough so as they do not to fit through the slots 18 in the circumferential rim section 14 of the base member 12. In contrast, the connective portions 54 are typically thinner than the ornate portions and are capable of fitting into the slots 18. The connective portions 54 operatively couple the multiple ornate portions 52 throughout the ornamental string 50. It is also pertinent to note that the ornate portions 52 are typically sized to fit generally within the circumferential trough section 16 of the base member 12 (and in some implementations, within the segments defined by the plurality of supporting arms 19 in the circumferential trough section 16).

With reference to FIG. 2, embodiments of the decorating assembly 10 typically comprise multiple ornamental strings 50 whereby each ornamental string 50 is removably coupled to a segment within the circumferential trough section 16 of the base member 12. Each of the one or the one or more ornamental strings 50 can be removably coupled to each segment in the circumferential trough section 16 of the base member 12 by locating a first ornate portion 52a within the circumferential trough section 16 and locating a first connective portion 54a within a one of the plurality of slots 18 (e.g., between two adjacent tabs of the circumferential rim section 14). Also note that the segments defined within the circumferential trough section 16 and each of the first ornate portions 52a therein are illustrated. The supporting arms 19 are shown extending radially from an inner wall of the circumferential trough section 16 proximal the center of the base member 12 to the circumferential rim section 14 and spaced between each of the plurality of slots 18.

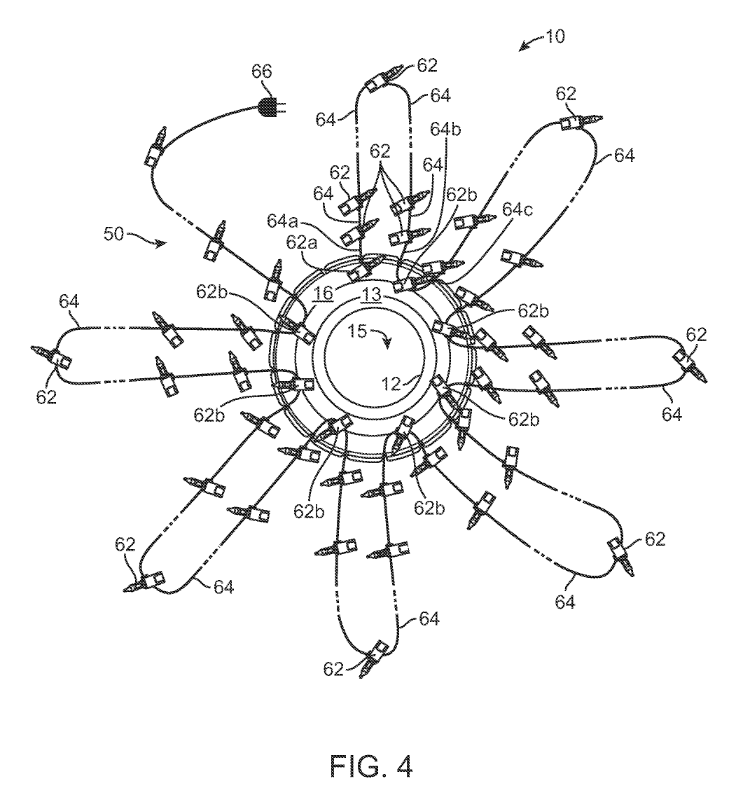

Now referring to FIG. 4, embodiments of the decorating assembly 10 can comprise a single ornamental string 50 whereby various portions of the single ornamental string 50 are removably coupled to or interlaced with segments in the circumferential trough section 16 of the base member 12. In FIG. 4, the single ornamental string 50 is illustrated as a light strand, but the single ornamental string 50 can be bead garland or any other type of ornamental string. In this exemplary embodiment, the ornate portions comprise one or more light-emitting bulbs 62 and the connective portions comprise one or more electrical wires 64. In this single ornamental string embodiment, a first light-emitting bulb 62a rests within the circumferential trough section 16 and a first electrical wire portion fits within a slot 18. Note that the first light-emitting bulb 62a need not necessarily be the very first (or end bulb) of the single light strand. The following several light-emitting bulbs 62 are left to hang down before a first intermediate electrical wire 64b is located within another of the plurality of slots 18. An intermediate light-emitting bulb 62b is then disposed within the circumferential trough 16 and a second intermediate electrical wire 64c is located into an immediately adjacent slot 18. This interlacing as described and illustrated can be repeated as necessary to obtain the desired appearance of the decorating assembly 10. A power plug 66 at an end of the light strand can be electrically coupled to an electrical outlet or wall socket to provide power to the light strand and create the desired ornamental appearance.

An Exemplary Method of Decorating a Tree with a Decorating Assembly

A new and useful exemplary method of decorating a tree is disclosed herein. It is to be understood that various embodiments of the decorating assembly 10 can be used in conjunction with exemplary method. By way of example but not limitation, a decorating assembly comprising light strands and/or bead garland as the one or more ornamental strings can be utilized in this method interchangeably.

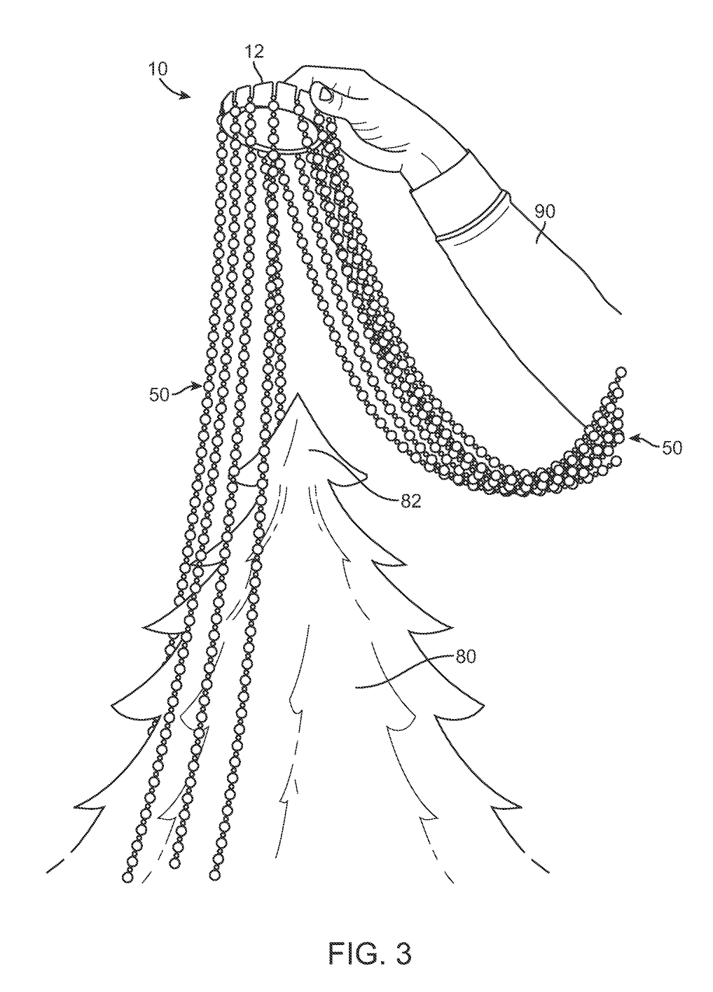

FIG. 3 illustrates the decorating assembly 10 and a tree 80 during the process of decorating the tree 80 using the exemplary method. The decorating assembly 10 comprises a base member 12 and one or more ornamental strings 50. The base member 12 comprises an aperture disposed in the approximate center of the base member 12, a rim section having a plurality of slots, a trough section, and an elevation section extending from the trough section to a top edge of the aperture. The one or more ornamental strings 50 are typically removably coupled to the base member 12.

A first operation of the exemplary method comprises providing an embodiment of the decorating assembly 10. It is to be appreciated that the decorating assembly 10 can be wholly contained within a container such as, but not limited to, a cellophane bag or cylinder/drum with the one or more ornamental strings 50 already coupled or preassembled to the base member 12. Such a pre-assembled decorating assembly and container provide an easy storage means and efficient packing/unpacking process of the decorative apparatus. For example, ornamental strings of bead garland, in particular, can be stored from season to season still coupled to the base member. Tangling of the ornamental strings 50 can be avoided by lowering the base member 12 with the pre-attached ornamental strings into the container, such as a cylindrical container/drum. When the decorating assembly 10 is next needed, the base member 12 with the pre-attached ornamental strings 50 can be pulled straight up and applied to the tree without having to first untangle them.

Next, a user 90 can hold the decorating assembly 10 with a first hand while the decorating assembly 10 is moved into position over the tree 80. Then, all or a portion of the one or more ornamental strings 50 can be held in a second hand (as illustrated by the bunched together portion of ornamental strings 50 on the right side of the tree 80 in FIG. 3). Next, the decorating assembly 10 is placed on a top branch 82 of the tree 80. This is accomplished in a similar manner as one would place a star, angel, or similar ornament at the top of a Christmas tree. However, it is to be appreciated that other methods of decorating a tree with the decorating assembly can comprise placement of the decorating assembly 10 on a branch of the tree that is not necessarily considered the top branch.

The decorating assembly 10 is typically placed on the general top portion of the tree 80 such that the top branch 82 of the tree 80 fits through the aperture of the base member 12. The base member 12 is oriented such that the one or more ornamental strings 50 stay coupled to the base member 12 and at least one first ornate portion rests within the trough section. The top branch 82 of the tree 80 passes through the aperture into the elevation section, which aids in stabilizing the decorating assembly 10 on the top portion or top branch 82 of the tree 80. As would be obvious to one of ordinary skill in the art, the one or more ornamental strings 50 can be placed and spread along the length and/or circumference of the tree, as well as within or generally inside of the tree, and arranged in a myriad of ways. For example, a generally vertical application whereby the one or more ornamental strings 50 are extended straight down the side of the tree may provide the desired look. However, a generally horizontal and/or spiral application can be achieved by looping relatively longer ornamental strings 50 around the girth of the tree.

In sum, the tree 80 can be quickly and elegantly decorated by a single person or user 90 of this exemplary method. In some implementations, each of the one or more ornamental strings 50 can be individually coupled to the base member 12, particularly when the user 90 desires to include custom-made ornamental strings. Yet in other implementations, each of the ornamental strings 50 can be pre-attached to the base member 12. Moreover, the one or more ornamental strings 50 can be cut to the appropriate length for the given tree and desired arrangement.

It is pertinent to note that a plurality of decorating assemblies 10 can be used to decorate as single tree as the base members 12 are generally stackable. Therefore, methods of decorating a tree can further include, for example, (i) placing a first decorating assembly having bead garland as the one or more ornamental strings, (ii) placing a second decorating assembly having light strands as the one or more ornamental strings on top of the first decorating assembly, and (iii) placing a third decorating assembly having tinsel as the one or more ornamental strings on top of the second decorating assembly.

### Alternative Embodiments and Variations

The various embodiments and variations thereof, illustrated in the accompanying figures and/or described above, are merely exemplary and are not meant to limit the scope of the invention. It is to be appreciated that numerous other variations of the invention have been contemplated, as would be obvious to one of ordinary skill in the art, given the benefit of this disclosure.

Embodiments of the decorating assembly and methods of use thereof may include use with different types and numbers of ornamental string. It is to be appreciated that embodiments of the decorating assembly can be used for a variety of festive occasions in numerous arrangements. For example, the annular base member can be placed on the top of an elongated pole or suspended in some manner from a ceiling and each distal end of the plurality of ornamental strings can be attached to a wall or other structure. Hence, an ornamental gazebo like effect can be created indoors or outdoors.

All variations of the invention disclosed in this provisional application are intended and contemplated to be within the spirit and scope of the invention.

I claim:

1. A decorating assembly for decorating a tree comprising:
an annular base member, the annular base member having an aperture disposed in the approximate center thereof, a circumferential rim section, a circumferential trough section, and a plurality of slots extending generally vertically from a top edge of the circumferential rim section proximal the circumferential trough section; and
one or more ornamental strings.

2. The decorating assembly of claim 1, wherein the annular base member comprises a unitary piece comprised of a plastic material.

3. The decorating assembly of claim 1, wherein the circumferential rim section is disposed in an outermost radial position with respect to the general center of the aperture.

4. The decorating assembly of claim 1, wherein at least one of the plurality of slots includes a widened opening portion, the widened opening portion disposed proximal the top edge of the circumferential rim section.

5. The decorating assembly of claim 1, wherein the annular base member further includes a generally frustoconical section extending from a top edge of the aperture to the circumferential trough section and a plurality of supporting arms, each of the plurality of supporting arms extending generally radially from an inner wall of the circumferential trough section proximal the aperture to a plurality of tabs disposed along the circumferential rim section.

6. The decorating assembly of claim 1, wherein the one or more ornamental strings includes an alternating and operatively coupled series of ornate portions and a connective portions, the ornate portions being larger than the connective portions whereby the ornate portions are capable of fitting substantially within the circumferential trough section of the annular base member and the connective portions are capable of fitting within each of the plurality of slots.

7. The decorating assembly of claim 6, wherein a first ornate portion is disposed within the circumferential trough section of the annular base member and a first connective portion is disposed within a one of the plurality of slots for each of the one or more ornamental strings.

8. The decorating assembly of claim 6, wherein a single ornamental string comprises the one or more ornamental strings, the single ornamental string having,
a first ornate portion being disposed within the circumferential trough section of the annular base member,
a first connective portion being disposed within a one of the plurality of slots,
one or more intermediate ornate portions being disposed within the circumferential trough section,
a first intermediate connective portion being within another of the plurality of slots, the first intermediate connective portion being adjacent and operatively coupled to the one or more intermediate ornate portions on a first side, and
a second intermediate connective portion being within another of the plurality of slots consecutive to the slot within which the first intermediate connective portion is disposed, the second intermediate connective portion being adjacent and operatively coupled to the one or more intermediate ornate portions on a second side.

9. The decorating assembly of claim 6, wherein the one or more ornamental strings comprises one or more strings of bead garland whereby the ornate portions comprise beads and the connective portions comprise strings.

10. The decorating assembly of claim 6, wherein the one or more ornamental strings comprises one or more light strands whereby the ornate portions comprise light-emitting bulbs and the connective portions comprise one or more electrical wires.

11. The decorating assembly of claim 1, wherein the plurality of slots comprises sixteen slots substantially equally spaced around the top edge of the circumferential rim section.

12. A method of decorating a tree with a decorating assembly comprising (i) a base member, the base member having an aperture disposed in the approximate center thereof, a rim section, a trough section, and a plurality of slots extending generally vertically from a top edge of the rim section proximal the trough section; and (ii) one or more ornamental strings, the method comprising:
providing the decorating assembly;
holding the base member of the decorating assembly in a first hand;
holding at least a portion of the one or more ornamental strings of the decorating assembly in a second hand;
coupling the base member of the decorating to a top, generally vertical branch of the tree; and
spreading the one or more ornamental strings onto the tree.

13. The method of decorating a tree with the decorating assembly recited in claim 12, wherein said providing the decorating assembly comprises providing the decorating assembly preassembled in a container whereby the base member is arranged on top of the one or more ornamental strings within the container.

14. The method of decorating a tree with the decorating assembly recited in claim 12, wherein the one or more ornamental strings comprises at least one light strand, the method further comprising,
electrically coupling an end of the at least one light strand to an electrical outlet.
